(19) United States
(12) Patent Application Publication
(10) Pub. No.: US 2020/0001892 A1
(43) Pub. Date: Jan. 2, 2020

(54) PASSENGER ASSISTING APPARATUS, METHOD, AND PROGRAM

(71) Applicant: OMRON Corporation, Kyoto-shi, KYOTO (JP)

(72) Inventors: Hatsumi AOI, Kyoto-shi (JP); Hiroshi SUGAHARA, Kyoto-shi (JP); Kazuyoshi OKAJI, Kyoto-shi (JP); Michie UNO, Kyoto-shi (JP); Koji TAKIZAWA, Kyoto-shi (JP)

(73) Assignee: OMRON Corporation, Kyoto-shi, KYOTO (JP)

(21) Appl. No.: 16/334,798

(22) PCT Filed: Jul. 20, 2017
(86) PCT No.: PCT/JP2017/026352

§ 371 Date: Mar. 20, 2019

(30) Foreign Application Priority Data
Mar. 8, 2017 (JP) 2017-043754

(51) Int. Cl. B60W 50/14; G06K 9/00; B60W 40/08; B60R 25/20; E05F 15/73

(52) U.S. Cl. CPC B60W 50/14; G06K 9/00845; B60W 40/08; B60W 2040/0818; E05F 15/73; B60W 2050/143; B60R 25/20

(57) ABSTRACT

In a passenger assisting apparatus, a passenger information obtaining unit obtains a destination and a contact of a passenger, a state determination unit determines, at the destination for example, whether the passenger is able to exit the vehicle based on a sensing result from a passenger state detection sensor for detecting a state of the passenger. An awakening assistance unit performs an awakening operation for the passenger when the state determination unit determines that the passenger is unable to exit the vehicle, and a contact notification unit provides a notification to the contact obtained by the passenger information obtaining unit when the state determination unit determines that the passenger is unable to exit the vehicle after the awakening operation.

### FIELD

The present invention relates to a passenger assisting apparatus, a passenger assisting method, and a passenger assisting program for assisting a passenger in an autonomous vehicle.

### BACKGROUND

Vehicles incorporating an automatic driving controller that assists vehicle driving operations have been developed and commercialized.

A variety of assisting apparatuses have been developed for assisting a driver in a vehicle with an automatic driving controller. For example, Japanese Unexamined Patent Application Publication No. 2014-044707 describes an assisting apparatus that assists a driver in an abnormal condition by determining the driver's health and assisting the driver in a low state of health depending on the level of the state.

### SUMMARY

Research is currently underway on driverless autonomous vehicles to be achieved by enhancing the capabilities of automatic driving controllers. Autonomous vehicles are expected to appear in the near future. With their increased vehicle costs and reduced driver costs, autonomous vehicles are expected to be used first as shared vehicles such as buses and taxis, rather than as private automobiles such as family cars.

Unlike buses, which take many passengers, taxis ordinarily carry a few passengers and often take one person. A passenger assisting apparatus is expected to be used when, for example, all of such a few passengers cannot exit, for example, they have fallen asleep, or when they need aid, for example, they suddenly become sick.

One or more aspects of the present invention are directed to a passenger assisting apparatus, a passenger assisting method, and a passenger assisting program for assisting a passenger unable to exit a vehicle incorporating an automatic driving controller such as a driverless autonomous vehicle.

In response to the above issue, a passenger assisting apparatus according to a first aspect of the present invention is mountable on an autonomous vehicle including an automatic driving controller and assists a passenger on the autonomous vehicle. The apparatus includes a passenger information obtaining unit that obtains a destination and a contact of the passenger, a state determination unit that determines whether the passenger is able to exit the vehicle based on a sensing result from a passenger state detection sensor for detecting a state of the passenger, and an awakening assistance unit that performs an awakening operation for the passenger when the state determination unit determines that the passenger is unable to exit the vehicle. The passenger assisting apparatus also includes a contact notification unit that provides a notification to the contact obtained by the passenger information obtaining unit when the state determination unit determines that the passenger is unable to exit the vehicle after the awakening operation performed by the awakening assistance unit.

A passenger assisting apparatus according to a second aspect of the present invention is the apparatus according to the first aspect further including an arrival determination unit that determines whether the autonomous vehicle has arrived at the destination of the passenger or reached a vicinity of the destination. When the arrival determination unit determines that the autonomous vehicle has arrived at the destination of the passenger or reached the vicinity, the state determination unit determines whether the passenger is able to exit the vehicle.

A passenger assisting apparatus according to a third aspect of the present invention is the apparatus according to the first or second aspect further including a situation determination unit that determines whether a person has come from the contact to pick up the passenger, and a door lock controller that locks a door at a doorway for the passenger at start of driving with at least the passenger on the autonomous vehicle, and unlock the door when the state determination unit determines that the passenger is able to exit the vehicle or the situation determination unit determines that a person has come from the contact to pick up the passenger.

A passenger assisting apparatus according to a fourth aspect of the present invention is the apparatus according to the third aspect in which the contact notification unit provides, to the contact, the notification including identification information identifying a person to pick up the passenger, and the situation determination unit determines that a person has come from the contact to pick up the passenger based on the identification information presented by the person.

A passenger assisting apparatus according to a fifth aspect of the present invention is the apparatus according to the third or fourth aspect further including a traveling-to-receiving place control unit that causes the automatic driving controller to move the autonomous vehicle to a predetermined receiving place and provide a notification to the receiving place when the situation determination unit determines that no person comes from the contact to pick up the passenger or when the contact notification unit fails to provide a notification to the contact. The door lock controller unlocks the door in response to arrival at the receiving place.

A passenger assisting apparatus according to a sixth aspect of the present invention is the apparatus according to the fifth aspect further including a receiving place designation unit that receives designation of the predetermined receiving place.

A passenger assisting apparatus according to a seventh aspect of the present invention is the apparatus according to any one of the first to sixth aspects in which the state determination unit further determines whether the passenger is in a state appropriate to receive the awakening operation performed by the awakening assistance unit based on the sensing result from the passenger state detection sensor for detecting the state of the passenger. The awakening assistance unit performs the awakening operation when the state determination unit determines that the passenger is in a state appropriate to receive the awakening operation.

A passenger assisting method according to an eighth aspect of the present invention is implemented by an apparatus mountable on an autonomous vehicle including an automatic driving controller to assist a passenger on the autonomous vehicle. The method includes obtaining a destination and a contact of the passenger, determining whether the passenger is able to exit the vehicle based on a sensing result from a passenger state detection sensor for detecting a state of the passenger, performing an awakening operation for the passenger when the passenger is determined unable to exit the vehicle in the determining whether the passenger is able to exit the vehicle, redetermining whether the passenger is able to exit the vehicle based on a sensing result from the passenger state detection sensor after the awakening operation is performed in the performing the awakening operation, and providing a notification to the contact obtained in the obtaining the destination and the contact of the passenger when the passenger is determined unable to exit the vehicle in the redetermining whether the passenger is able to exit the vehicle.

A program according to a ninth aspect of the present invention causes a computer to function as the units included in the passenger assisting apparatus according to any one of the first to seventh aspects.

The apparatus and the method according to the first and eighth aspects of the present invention allow the autonomous vehicle to obtain the destination of its passenger such as the home as well as the telephone number or another contact about the destination. When the passenger is unable to exit the vehicle normally, like when the passenger is asleep, a stimulus such as sound or vibration is first provided to the passenger to promote awakening. When the passenger remains asleep, a notification, or a request to pick up the passenger, is provided to the obtained contact. The unawakened passenger can then be received by the person coming for the passenger, and thus can be safely and reliably sent to the destination.

The apparatus according to the second aspect of the present invention determines whether the passenger is able to exit the vehicle when the autonomous vehicle arrives at the passenger's destination or reaches its vicinity. The determination is not performed when the vehicle will take some time before arriving at the destination. This eliminates a redundant operation and achieves power saving. When the vehicle arrives at the destination or reaches its vicinity, the apparatus determines whether the passenger is able to exit the vehicle. Thus, the determination result indicating whether the passenger is able to exit has been obtained to determine whether to perform an awakening operation or provide a notification to the contact.

The apparatus according to the third aspect of the present invention unlocks the door when determining that a person has come to pick up the passenger. This apparatus keeps the door locked to protect the passenger from troubles such as theft, which may otherwise be caused by freely unlocking the door for the unawakened passenger. The apparatus unlocks the door to allow the passenger to be received by the person who has come to pick up the passenger.

The apparatus according to the fourth aspect of the present invention provides identification information when providing the request to pick up the passenger, and thus can identify the person who has come to pick up the passenger using the identification information presented by the person. This apparatus thus ensures the safety of the passenger by keeping the door unlocked when a person other than the person requested to pick up the passenger approaches.

The apparatus according to the fifth aspect of the present invention can cause the vehicle to travel to a predetermined receiving place, such as a contracted security agency, a police station, or a hospital to send the passenger to be received by a security officer, a police officer, or a doctor when no person comes from the contact to pick up the passenger, no person answers the call to the contact, or the request to pick up the passenger is rejected.

The apparatus according to the sixth aspect of the present invention allows, for example, contacting a taxi dispatch center or calling an emergency telephone number for police or rescue to receive the designation of a receiving place depending on the passenger state, and can cause the vehicle to travel to the designated receiving place. This allows the vehicle to send the passenger to an appropriate receiving place determined based on the distance from the current position of the vehicle and the capability of the receiving place.

The apparatus according to the seventh aspect of the present invention performs an awakening operation when the passenger is in a state appropriate to receive the awakening operation. More specifically, when the passenger is in a state inappropriate to receive the awakening operation, for example, when the passenger specifying a hospital as the destination becomes sicker during travel to the hospital and unable to exit the vehicle, the awakening operation is not performed for the passenger. This ensures the safety of the passenger by providing no stimulus to the passenger in a state inappropriate to receive a stimulus.

The program according to the ninth aspect of the present invention causes the computer to function as the units included in the passenger assisting apparatus according to any one of the first to seventh aspects.

The passenger assisting apparatus, method, and program according to these aspects of the present invention assist a passenger on a vehicle incorporating an automatic driving controller such as a driverless autonomous vehicle when the passenger becomes unable to exit the vehicle.

### BRIEF DESCRIPTION OF THE DRAWINGS

FIG. 1 is a schematic diagram of an automatic driving control system including a passenger assisting apparatus according to a first embodiment of the present invention.

FIG. 2 is a functional block diagram of the passenger assisting apparatus according to the first embodiment of the present invention.

FIG. 3 is a flowchart showing the procedure and operation for assisting a passenger performed by the passenger assisting apparatus shown in FIG. 2.

FIG. 4 is a functional block diagram of a passenger assisting apparatus according to a second embodiment of the present invention.

FIG. 5 is a flowchart showing the procedure and operation for assisting a passenger performed by the passenger assisting apparatus shown in FIG. 4.

FIG. 6 is a flowchart showing the procedure and operation for assisting a passenger performed by a passenger assisting apparatus according to a third embodiment of the present invention.

FIG. 7 is a flowchart showing the procedure and operation for assisting a passenger performed by a passenger assisting apparatus according to a fourth embodiment of the present invention.

### DETAILED DESCRIPTION

### Embodiments

One or more embodiments of the present invention will now be described with reference to the drawings.

### First Embodiment

### Structure

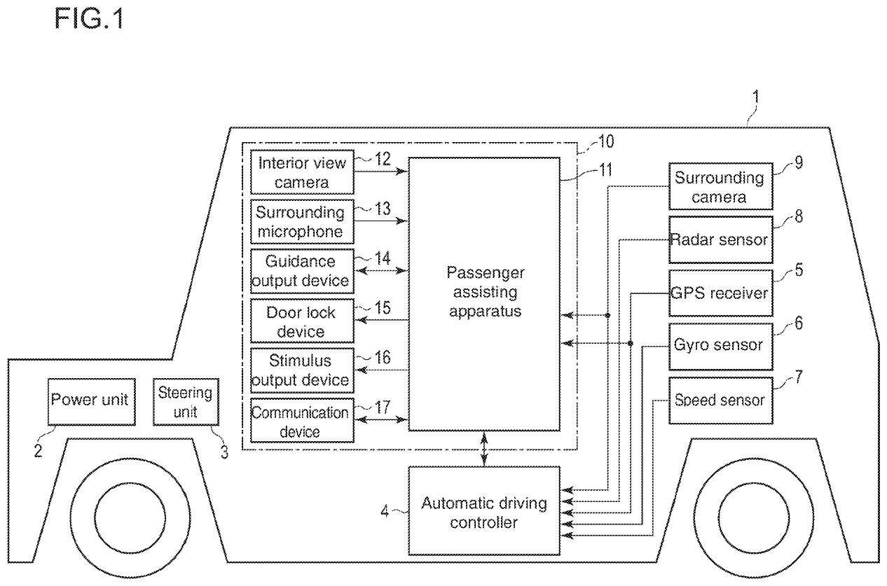

FIG. 1 is a schematic diagram of an automatic driving control system including a passenger assisting apparatus according to a first embodiment of the present invention. The automatic driving control system is mounted on a vehicle 1. The vehicle 1 may be a driverless, fully automated taxi in this embodiment.

The vehicle 1 includes, as its basic components, a power unit 2 including a power supply and a transmission, and a steering unit 3. The power supply includes an engine, a motor, or both.

The vehicle 1 can travel in a driverless automatic drive mode. For example, the automatic drive mode enables a driving status in which the vehicle 1 automatically travels a roadway to a destination specified by a passenger, without a driver performing a driving operation. The vehicle 1 may switch to a manual drive mode as appropriate, in which the driver operates the vehicle 1.

In FIG. 1, the vehicle 1 includes an automatic driving controller 4 for controlling driving in the automatic drive mode. The automatic driving controller 4 obtains sensing data from a global positioning system (GPS) receiver 5, a gyro sensor 6, and a speed sensor 7. The automatic driving controller 4 automatically controls the traveling of the vehicle 1 by controlling the steering, the accelerator, and the brake based on route information generated by a navigation system (not shown), traffic information obtained through road-to-vehicle communication, and information obtained by a surrounding monitoring system that monitors the positions and movements of nearby pedestrians and vehicles. The surrounding monitoring system includes, for example, a radar sensor 8 and a surrounding camera 9. The radar sensor 8 measures a distance from a nearby vehicle and outputs the distance information to the automatic driving controller 4. The surrounding camera 9 captures images of areas surrounding the vehicle, and outputs video signals representing the captured images to the automatic driving controller 4.

The automatic driving control includes autosteering (automatic steering during driving) and automatic speed regulation (automatic speed regulation during driving). Autosteering enables a driving state in which the steering unit 3 is controlled automatically. Autosteering includes lane keeping assist (LKA). LKA automatically controls the steering unit 3 to prevent the vehicle 1 from leaving the driving lane. Autosteering is not limited to LKA. Automatic speed regulation enables a driving state in which the speed of the vehicle 1 is controlled automatically. Automatic speed regulation includes adaptive cruise control (ACC). For example, ACC controls the vehicle 1 to travel at a predefined constant speed while no preceding vehicle is traveling ahead of the vehicle 1. With a preceding vehicle traveling ahead of the vehicle 1, ACC performs tracking control to regulate the speed of the vehicle 1 in accordance with the distance from the preceding vehicle. Automatic speed regulation is not limited to ACC, but may include cruise control (CC).

The automatic driving control system according to the present embodiment includes a passenger assisting system 10 for assisting a passenger. The passenger assisting system 10 includes the passenger assisting apparatus 11 according to the first embodiment of the present invention, and interior view cameras 12, a surrounding microphone (hereafter simply, a microphone) 13, a guidance output device 14, a door lock device 15, a stimulus output device 16, and a communication device 17, which are connected to the passenger assisting apparatus 11. The GPS receiver 5 and the surrounding camera 9 are also connected to the passenger assisting apparatus 11 and function as a part of the passenger assisting system 10.

Each interior view camera 12 functions as a passenger state detection sensor for detecting the state of a passenger. For example, the interior view cameras 12 are installed at positions to capture images of the faces and bodies of passengers, for example, on the dashboard, the back surface of the front seat headrest, the inner ceiling, and a side surface. Each interior view camera 12 captures an image of the passenger in the corresponding seat and outputs the video signal to the passenger assisting apparatus 11.

The surrounding microphone 13 functions as a sensor for detecting any surrounding sound of the vehicle 1. For example, the surrounding microphone 13 is installed near a door at a doorway for a passenger to detect sound outside the vehicle. The microphone 13 picks up sound near the door, which is produced by the passenger or a person to pick up the passenger, and outputs the sound signal to the passenger assisting apparatus 11. The surrounding microphone 13 may also function as a part of the surrounding monitoring system used by the automatic driving controller 4.

The guidance output device 14 outputs guidance information received from the passenger assisting apparatus 11. For example, the guidance output device 14 includes a speaker and a display. The guidance output device 14 outputs, from the speaker, a sound signal representing the guidance information output from the passenger assisting apparatus 11, and displays a display signal representing the guidance information on the display. The guidance output device 14 also includes a microphone. The guidance output device 14 outputs guidance information asking the passenger's destination and contact, and the passenger produces a voice indicating the destination and the contact. The microphone picks up the voice and outputs the sound signal to the passenger assisting apparatus 11. The guidance output device 14 may also have the same functions as the image displaying function, the touch input function, and the sound input and output function of the navigation system to allow a passenger to input the destination and the contact. The guidance output device 14 outputs the entered destination and contact information to the passenger assisting apparatus 11. The guidance output device 14 may eliminate some of these components to at least obtain the passenger's destination and contact.

The guidance output device 14 may further have, for example, a card reader function as a part of the taxi system included in a fully automated taxi to read information from, for example, a credit card, a prepaid card, and a membership card, and may receive a fare from the passenger through the communication device 17. This function allows the passenger's address information and telephone number information to be obtained through the communication device 17 based on the information in the credit card or the membership card. In this case, when the destination designated by the passenger matches the passenger's address information, the telephone number information can be used as the contact. This eliminates asking the passenger for the contact. The guidance output device 14 may also have an automatic cash receipt and change returning function for fare payment in cash.

The door lock device 15 is installed on the door at each doorway for the passenger to lock or unlock the door as controlled by the passenger assisting apparatus 11.

The stimulus output device 16 is controlled by the passenger assisting apparatus 11 to provide a stimulus such as sound, light, or vibration to the passenger.

The sound or light generator may be a separate speaker or lamp or a part of the guidance output device 14. The vibration generator includes, for example, a vibrator that provides pulses on the seat surface under the passenger and a seat belt adjuster that repeatedly extends and withdraws the seat belt on the passenger in small amounts.

The communication device 17 is controlled by the passenger assisting apparatus 11 to communicate with a predetermined taxi dispatch center, and call the contact over a public telephone network as appropriate.

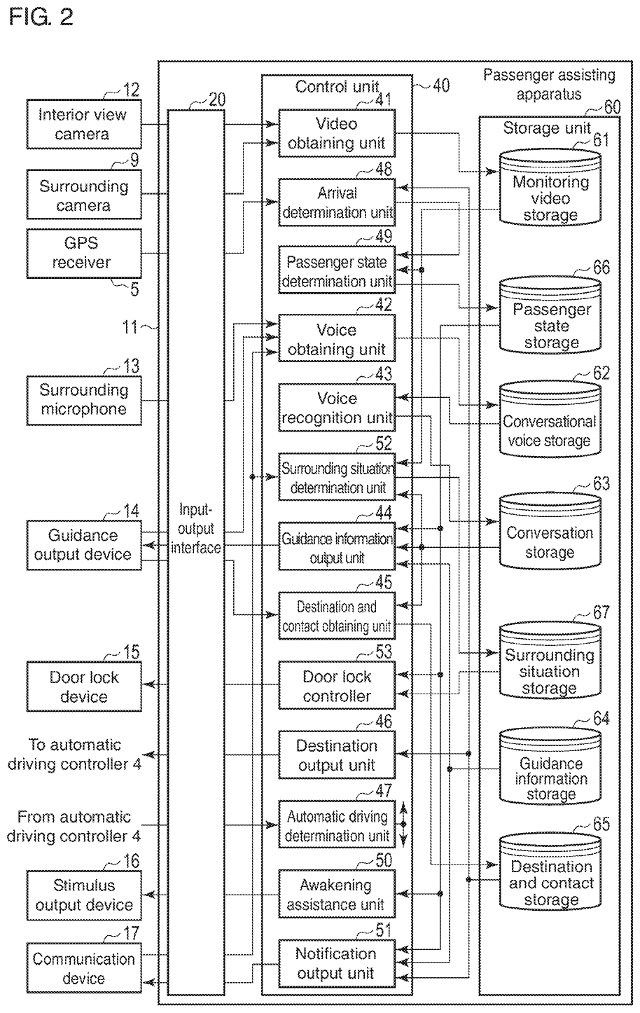

The passenger assisting apparatus 11, which assists the passenger, has the structure described below. FIG. 2 is a functional block diagram of the apparatus.

The passenger assisting apparatus 11 includes an input-output interface 20, a control unit 40, and a storage unit 60.

The input-output interface 20 receives video signals output from the interior view cameras 12 and the surrounding camera 9, converts the received signals into digital data, and inputs the digital data into the control unit 40. The input-output interface 20 also receives current positional information indicating the current position of the vehicle 1 from the GPS receiver 5, and inputs the information into the control unit 40. The input-output interface 20 further receives sound signals output from the surrounding microphone 13, the guidance output device 14, and the communication device 17, converts the received signals into digital data, and inputs the digital data into the control unit 40. The input-output interface 20 further receives the passenger's destination and contact information output from the guidance output device 14, and inputs the information into the control unit 40.

The input-output interface 20 converts the guidance information output from the control unit 40 into a sound signal and a display signal, and outputs the signals to the guidance output device 14. The input-output interface 20 also converts door control information output from the control unit 40 into a door lock or unlock signal, and outputs the signal to the door lock device 15. The input-output interface 20 also converts awakening assistance information output from the control unit 40 into a stimulus output device activation signal, and outputs the signal to the stimulus output device 16. The input-output interface 20 also converts contact information output from the control unit 40 into a telephone number signal, and outputs the signal to the communication device 17. The input-output interface 20 further converts guidance information output from the control unit 40 into a sound signal, and outputs the signal to the communication device 17.

The input-output interface 20 further communicates information between the automatic driving controller 4 and the control unit 40.

The storage unit 60 includes, as storage media, a nonvolatile memory, such as a solid state drive (SSD) or a hard disk drive (HDD), which is writable and readable as appropriate. The storage unit 60 may also include a volatile memory, such as a random access memory (RAM). The storage unit 60 includes, as storage areas used for implementing the present embodiment, a monitoring video storage 61, a conversational voice storage 62, a conversation storage 63, a guidance information storage 64, a destination and contact storage 65, a passenger state storage 66, and a surrounding situation storage 67. The monitoring video storage 61 stores monitoring videos of the interior and surrounding areas of the vehicle 1. The conversational voice storage 62 stores conversational voices received through communication and obtained inside or near the outside door. The conversation storage 63 stores conversations with the passenger and a person from the contact coming to pick up the passenger. The guidance information storage 64 stores the guidance information. The destination and contact storage 65 stores the destination and the contact. The passenger state storage 66 stores the states of the passenger. The surrounding situation storage 67 stores information indicating whether the person has come from the contact to pick up the passenger.

The control unit 40 includes, as its control functions for implementing the present embodiment, a video obtaining unit 41, a voice obtaining unit 42, a voice recognition unit 43, a guidance information output unit 44, a destination and contact obtaining unit 45, a destination output unit 46, an automatic driving determination unit 47, an arrival determination unit 48, a passenger state determination unit 49, an awakening assistance unit 50, a notification output unit 51, a surrounding situation determination unit 52, and a door lock controller 53. The control unit 40 may be a computer including a central processing unit (CPU) and a program memory, and any of the control functions may be implemented by the CPU executing programs stored in the program memory.

The video obtaining unit 41 obtains a monitoring video of a passenger in each seat from the corresponding interior view camera 12. The video obtaining unit 41 obtains monitoring videos of areas surrounding the vehicle 1 from the surrounding camera 9. The video obtaining unit 41 receives, through the input-output interface 20, digital data (passenger monitoring video data and surrounding monitoring video data) for video signals output from the interior view cameras 12 and the surrounding camera 9, and stores the received monitoring video data into the monitoring video storage 61 included in the storage unit 60.

The interior view camera 12 and the surrounding camera 9 or the input-output interface 20 may encode the video signals with a predetermined encoding scheme. This reduces the amount of monitoring video data, thus saving the memory capacity of the monitoring video storage 61.

The voice obtaining unit 42 obtains a voice of a person near the vehicle door from the surrounding microphone 13. The voice obtaining unit 42 also obtains a voice of the passenger from the microphone included in the guidance output device 14. The voice obtaining unit 42 further obtains a voice of a called person from the communication device 17. The voice obtaining unit 42 captures the digital data representing the voice signals output from the surrounding microphone 13, the guidance output device 14, and the communication device 17 (conversational voice data) through the input-output interface 20, and stores the captured conversational voice data into the conversational voice storage 62 in the storage unit 60.

The voice recognition unit 43 has a voice recognition dictionary and transforms voice data into text data through voice recognition on the voice data. For example, the voice recognition unit 43 performs voice recognition on input conversational voice data for each voice input into the conversational voice storage 62, and stores the recognized conversational information into the conversation storage 63 in the storage unit 60.

The guidance information output unit 44 reads prestored guidance information from the guidance information storage 64 and outputs the information to the guidance output device 14. The guidance information read from the guidance information storage 64 and output by the guidance information output unit 44 depends on the conversation with the passenger stored in the conversation storage 63 and the determination results from the passenger state determination unit 49. The determination results are stored in the passenger state storage 66 described later.

The destination and contact obtaining unit 45 obtains the passenger's destination and the contact. The destination and contact obtaining unit 45 reads the conversation with the passenger stored in the conversation storage 63 to obtain the destination and the contact, and stores the obtained destination and contact information into the destination and contact storage 65 in the storage unit 60. The destination and contact obtaining unit 45 may obtain the destination and contact information entered through the guidance output device 14, and store the received destination and contact information into the destination and contact storage 65 in the storage unit 60.

The destination output unit 46 outputs the passenger's destination to the automatic driving controller 4. The destination output unit 46 reads the destination information stored in the destination and contact storage 65, and outputs the information to the automatic driving controller 4.

The automatic driving determination unit 47 determines an automatic driving state in which, for example, the vehicle 1 is currently traveling, is parked, or has arrived at the destination based on various items of information about automatic driving output from the automatic driving controller 4. The control unit 40 causes each of the units to function to implement the present embodiment based on the determination result from the automatic driving determination unit 47.

The arrival determination unit 48 determines whether the vehicle 1 has arrived at the passenger's destination. The arrival determination unit 48 reads the destination information stored in the destination and contact storage 65, and determines the arrival at the destination by comparing the read destination information with the current positional information indicating the current position of the vehicle 1 received from the GPS receiver 5.

The passenger state determination unit 49 determines the state of the passenger. The passenger state determination unit 49 reads the passenger monitoring video data from the monitoring video storage 61 when the arrival determination unit 48 determines that the vehicle 1 has arrived at the destination. Based on the passenger monitoring video data, the passenger state determination unit 49 determines whether the passenger is able (or unable) to exit the vehicle. The state in which the passenger is unable to exit the vehicle may be when the passenger has fallen asleep or suddenly becomes sick. The passenger state determination unit 49 stores the determination results into the passenger state storage 66.

The passenger state determination unit 49 can also determine the passenger state (able or unable to exit the vehicle) depending on, for example, whether the seat belt is unlatched, in addition to the passenger monitoring video data stored in the monitoring video storage 61. More specifically, the vehicle 1 starts driving under the state in which the passenger wears the seat belt. Thus, the passenger still wearing the seat belt after the arrival at the destination is determined unable to exit the vehicle.

The awakening assistance unit 50 allows the stimulus output device 16 to provide a stimulus to the passenger. The awakening assistance unit 50 reads the passenger state stored in the passenger state storage 66. For the passenger unable to exit the vehicle, the awakening assistance unit 50 outputs awakening assistance information to the stimulus output device 16 to promote the awakening of the passenger by providing a stimulus to the passenger.

The notification output unit 51 allows the communication device 17 to provide a notification, or a request to pick up the passenger, to the contact. The notification output unit 51 reads the passenger state stored in the passenger state storage 66. For the passenger remaining unable to exit the vehicle after receiving the stimulus output from the stimulus output device 16, the notification output unit 51 reads the telephone number indicated by the passenger's contact stored in the destination and contact storage 65, and outputs the telephone number to the communication device 17. The communication device 17 uses the telephone number to call the contact. The notification output unit 51 also reads the guidance information stored in the guidance information storage 64 and outputs the information to the communication device 17. This allows the communication device 17 to provide voice guidance that requests the person answering the telephone to pick up the passenger. The voice guidance includes identification information such as a password, a personal identification number (PIN), and a callback telephone number used to identify the person to pick up the passenger. The callback telephone number may be a number unique to the vehicle 1 or any other predetermined number such as the number of a taxi dispatch center.

The surrounding situation determination unit 52 determines the surrounding situation of the vehicle 1 to determine whether a person has come from the contact to pick up the passenger. The surrounding situation determination unit 52 reads the surrounding monitoring video data from the monitoring video storage 61. When a person approaches the vehicle door, the surrounding microphone 13 captures a conversation with the person, and the surrounding situation determination unit 52 reads the captured conversation from the conversation storage 63 to determine whether a person has come from the contact to pick up the passenger. The determination is achieved based on whether the conversation includes the identification information used to identify the person to pick up the passenger. When a person approaches the vehicle door, the surrounding situation determination unit 52 can determine whether the person has come to pick up the passenger by determining whether the surrounding monitoring video data from the monitoring video storage 61 indicates that the person is calling, and the communication device 17 has received a callback from the contact or a notification of callback receipt from the taxi dispatch center. The surrounding situation determination unit 52 stores the determination results into the surrounding situation storage 67.

The door lock controller 53 controls the door lock device 15. The door lock controller 53 causes the door lock device 15 to lock the door when the automatic driving determination unit 47 determines the start of the automatic driving or when the destination output unit 46 outputs the destination information. More specifically, the door lock controller 53 locks the door at the start of the automatic driving with at least a passenger on the vehicle. The door lock controller 53 also reads the passenger state stored in the passenger state storage 66, and causes the door lock device 15 to unlock the door when the passenger is able to exit the vehicle. The door lock controller 53 further reads the surrounding situation information stored in the surrounding situation storage 67, and causes the door lock device 15 to unlock the door when a person has come from the contact to pick up the passenger. In addition, the door lock controller 53 may include a seat belt locking mechanism that locks the seat belt for fare payment in cash until the fare is paid. The door lock controller 53 may control the seat belt lock in synchronization with the door lock control.

### Operation

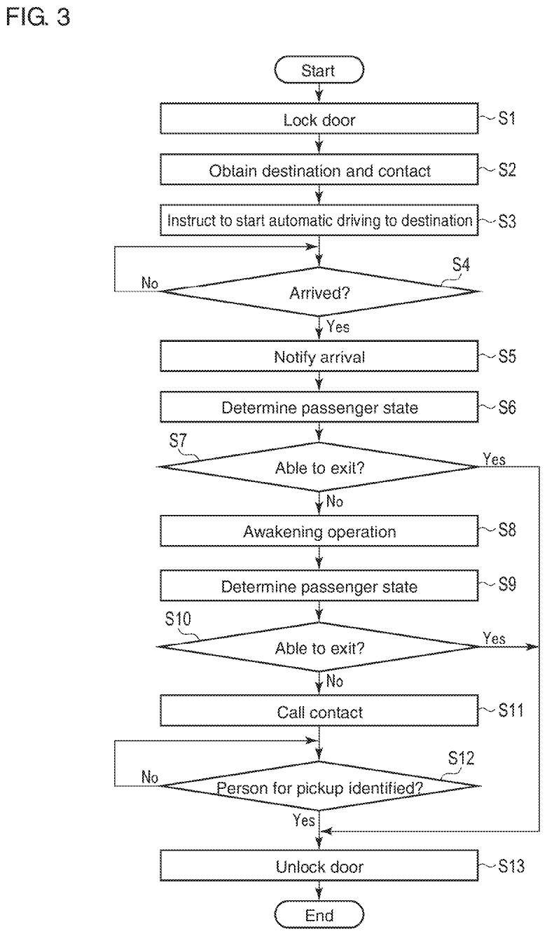

The operation of the passenger assisting apparatus 11 with the above structure will now be described. FIG. 3 is a flowchart showing the overall procedure and operation for assisting the passenger.

The procedure in the flowchart starts when a passenger enters the vehicle. The preceding procedure for finding a passenger is provided in the taxi system using fully automated driving, and will not be described.

### 1. Passenger Entering the Vehicle

When a passenger enters the vehicle, the passenger assisting apparatus 11 controls the door lock device 15 with the door lock controller 53 in the control unit 40 to lock the door in step S1.

### 2. Obtaining Destination and Contact

In step S2, the passenger assisting apparatus 11 obtains the passenger's destination and contact. For example, the guidance information output unit 44 in the control unit 40 outputs guidance information that asks for the passenger's destination and contact from the guidance output device 14. The passenger assisting apparatus 11 receives the input destination and contact through the microphone, the display, or the touch panel of the guidance output device 14, and the destination and contact obtaining unit 45 obtains and stores the destination and the contact into the destination and contact storage 65 in the storage unit 60.

The destination may be the passenger's home and the contact about the home can be obtained from, for example, card information, or the destination may be searched for using the telephone number. This eliminates input of the contact by the passenger. The destination may be a public facility such as a hospital or a municipal office for which the telephone number is known. This also eliminates input of the contact by the passenger.

The door locking in step S1 may follow step S2.

### 3. Automatic Driving

Once the destination and the contact are obtained, the passenger assisting apparatus 11 instructs the automatic driving controller 4 to start automatic driving to the passenger destination in step S3. For example, the destination output unit 46 in the control unit 40 reads the destination information from the destination and contact storage 65, and outputs the destination information to the automatic driving controller 4. The automatic driving controller 4 drives automatically to the destination in accordance with the output destination information. The operation of the automatic driving controller 4 is not directly related to the present embodiment, and will not be described.

In step S4, the passenger assisting apparatus 11 waits until the vehicle 1 arrives at the destination. For example, the arrival determination unit 48 in the control unit 40 compares the current positional information indicating the current position of the vehicle 1 obtained by the GPS receiver 5 with the destination information stored in the destination and contact storage 65, and determines whether these sets of information match. The processing in this step is repeated until the sets of information match.

When the vehicle 1 arrives at the destination, the passenger assisting apparatus 11 notifies the passenger of the arrival in step S5. For example, the guidance information output unit 44 in the control unit 40 outputs the guidance information indicating the arrival at the destination through the guidance output device 14.

### 4. Determining Passenger State

The passenger assisting apparatus 11 determines whether the passenger is able to exit the vehicle. For example, in step S6, the passenger state determination unit 49 in the control unit 40 reads the passenger monitoring video data from the monitoring video storage 61, and determines the states of all passengers based on the passenger monitoring video data. The passenger state determination unit 49 stores the determination result information into the passenger state storage 66.

The passenger states determined by the passenger state determination unit 49 include the passenger's state being awake or asleep. For example, the passenger state determination unit 49 detects information such as the degree of eye opening, posture, and movements of the passenger based on the passenger monitoring video data to recognize that the passenger is asleep or preparing for fare payment or exiting the vehicle. The passenger state determination unit 49 may also use auxiliary information such as the passenger's snores in the interior sound obtained by the voice obtaining unit 42 through the microphone included in the guidance output device 14. In addition, the unlatched state of the seat belt may also be used.

For a plurality of passengers on the vehicle, the passenger state determination unit 49 determines that the passengers are able to exit the vehicle unless all of them are asleep. When all the passengers are asleep, the passenger state determination unit 49 determines that the passengers are unable to exit the vehicle.

The passenger assisting apparatus 11 determines whether the determination result information stored in the passenger state storage 66 indicates a state in which the passenger is able to exit the vehicle. For example, in step S7, the control unit 40 reads the determination result obtained by the passenger state determination unit 49 and stored in the passenger state storage 66, and determines whether the determination result indicates a state in which the passenger is able to exit the vehicle. When the determination result from the passenger state determination unit 49 indicates a state in which the passenger is able to exit the vehicle, the passenger assisting apparatus 11 advances the processing to step S13 described later. When the determination result from the passenger state determination unit 49 indicates a state in which the passenger is unable to exit, the passenger assisting apparatus 11 advances the processing to step S8.

### 5. Awakening Operation

The passenger assisting apparatus 11 in step S8 performs a passenger awakening operation. For example, the awakening assistance unit 50 in the control unit 40 reads the passenger state determination result stored in the passenger state storage 66. When all the passengers are unable to exit the vehicle, the awakening assistance unit 50 outputs awakening assistance information to the stimulus output device 16. The stimulus output device 16 then provides a stimulus to the passengers to promote awakening of the passengers.

### 6. Providing Notification to Contact

After a predetermined time period such as one minute from the start of the awakening operation, the passenger assisting apparatus 11 redetermines whether the passenger is able to exit the vehicle. For example, in step S9, the passenger state determination unit 49 in the control unit 40 reads the passenger monitoring video data from the monitoring video storage 61, determines the states of all passengers based on the passenger monitoring video data, and stores the determination result information into the passenger state storage 66. The passenger assisting apparatus 11 then determines whether the determination result information stored in the passenger state storage 66 indicates a state in which each passenger is able to exit the vehicle, or more specifically, the passengers have awakened. For example, in step S10, the control unit 40 reads the determination result obtained by the passenger state determination unit 49 and stored in the passenger state storage 66, and determines whether the determination result indicates a state in which each passenger is able to exit the vehicle. When the determination result indicates a state in which each passenger is able to exit the vehicle, the passenger assisting apparatus 11 advances the processing to step S13 described later. When the determination result indicates a state in which each passenger is unable to exit, the passenger assisting apparatus 11 advances the processing to step S11.

In step S11, the passenger assisting apparatus 11 provides a notification to the passenger's contact. For example, the notification output unit 51 in the control unit 40 reads the passenger state determination result stored in the passenger state storage 66. When all the passengers remain unable to exit the vehicle, the notification output unit 51 reads the telephone number indicated by the contact of each passenger stored in the destination and contact storage 65, and causes the communication device 17 to call the contact. The notification output unit 51 then reads guidance information stored in the guidance information storage 64, such as voice guidance that requests a person to pick up the passengers, and provides the information to the person answering the telephone through the communication device 17. The voice guidance includes identification information used to identify the person to pick up the passengers.

### 7. Identifying Person to Pick Up Passenger

After a notification is provided to the contact, the passenger assisting apparatus 11 in step S12 determines whether a person has come from the contact to pick up the passengers. For example, the surrounding situation determination unit 52 in the control unit 40 reads the surrounding monitoring video data from the monitoring video storage 61, and determines whether a person is approaching the vehicle door. In response to a person approaching the vehicle door, the surrounding microphone 13 picks up a conversation with the person, and the surrounding situation determination unit 52 reads the conversational information from the conversation storage 63 to determine whether the conversation includes the identification information. In other cases, the surrounding situation determination unit 52 determines whether the surrounding monitoring video data from the monitoring video storage 61 indicates that the person is calling, and the communication device 17 has received a notification of callback receipt. More specifically, the surrounding situation determination unit 52 determines whether the person presents the identification information. Depending on the presentation of identification information, the surrounding situation determination unit 52 determines whether a person has come from the contact to pick up the passengers, and stores the determination result into the surrounding situation storage 67.

In this manner, the passenger assisting apparatus 11 waits for a person to come from the contact to pick up the passengers.

The vehicle 1 may have a guidance unit that outputs guidance information to an outside person by sound or text. When a person approaches the vehicle door, the surrounding situation determination unit 52 may output guidance information that asks the person to present the identification information. The identification information may not be input by voice. For example, a key input unit such as a numeric keypad may be installed on the door to receive the identification information.

### 8. Passenger Exiting the Vehicle

After identifying the person coming to pick up the passengers, the passenger assisting apparatus 11 causes the door lock controller 53 in the control unit 40 to control the door lock device 15 to unlock the door in step S13.

For the subsequent procedure for receiving the fare, the function is provided in the taxi system using fully automated driving, and will not be described.

### Effects

In some situations, the passenger may be totally drunk and have fallen asleep, and cannot awaken readily after the arrival at the destination such as the passenger's home. In this case, the driver may shake and awaken the passenger. Whereas a non-autonomous taxi with a driver can handle a sleeping passenger in this manner, a taxi that operates in a fully automated drive mode cannot handle such situations of a passenger. The apparatus according to the first embodiment of the present invention allows a taxi operating in a fully automated drive mode to obtain the passenger's contact in addition to the destination. When the passenger is unable to exit the vehicle normally, for example, when the passenger is falling asleep when detecting the arrival at the destination, a stimulus such as sound or vibration is first provided to the passenger to promote awakening. When the passenger remains asleep, a notification, or a request to pick up the passenger, is provided to the obtained contact. Thus, the apparatus according to the first embodiment assists the passenger in a driverless autonomous vehicle when the passenger becomes unable to exit the vehicle.

The apparatus according to the first embodiment of the present invention unlocks the door after detecting the person coming to pick up the passenger. This apparatus keeps the door locked to protect the passenger from troubles such as theft, which may otherwise be caused by freely unlocking the door for the unawakened passenger. The apparatus according to the first embodiment unlocks the door to pass allow the passenger to be received by the person who has come to pick up the passenger. The passenger can thus be safely and reliably sent to the destination.

Additionally, the apparatus unlocks the door after identifying the person coming to pick up the passenger based on the presented identification information. This ensures the safety of the passenger.

### Second Embodiment

### Structure

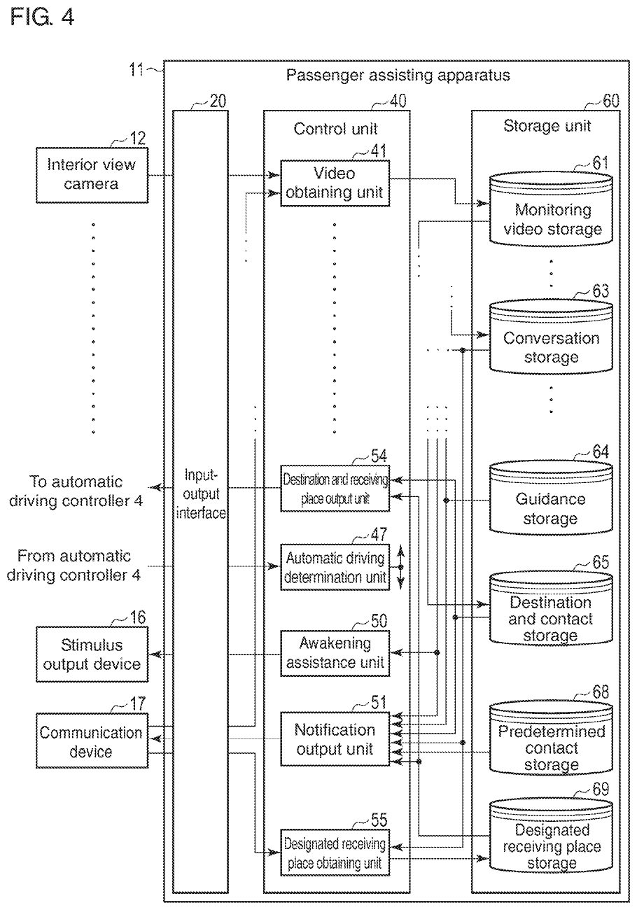

FIG. 4 is a functional block diagram of a passenger assisting apparatus 11 according to a second embodiment of the present invention. Some components are the same as in the passenger assisting apparatus 11 in FIG. 2 according to the first embodiment, and not shown to simplify the drawing.

The passenger assisting apparatus 11 according to the second embodiment also includes an input-output interface 20, a control unit 40, and a storage unit 60, as in the first embodiment.

The storage unit 60 includes, as storage areas used for implementing the present embodiment, a monitoring video storage 61, a conversational voice storage 62, a conversation storage 63, a guidance information storage 64, a destination and contact storage 65, a passenger state storage 66, and a surrounding situation storage 67, which are the same as in the first embodiment. The storage unit 60 in the second embodiment further includes a predetermined contact storage 68 and a designated receiving place storage 69. The predetermined contact storage 68 stores a predetermined contact used when the first contact cannot be reached. The predetermined contact includes the network address or the telephone number of the taxi dispatch center, and the telephone number of the security agency with which the taxi company has contracted. The predetermined contact may also be an emergency telephone number for police or rescue. The designated receiving place storage 69 stores a receiving place designated by an operator of the taxi dispatch center, the security agency, or an emergency call center.

The control unit 40 includes, as its control functions for implementing the present embodiment, a video obtaining unit 41, a voice obtaining unit 42, a voice recognition unit 43, a guidance information output unit 44, a destination and contact obtaining unit 45, an automatic driving determination unit 47, an arrival determination unit 48, a passenger state determination unit 49, an awakening assistance unit 50, a notification output unit 51, a surrounding situation determination unit 52, and a door lock controller 53, which are the same as in the first embodiment. The destination output unit 46 in the first embodiment is replaced with a destination and receiving place output unit 54. The control unit 40 in the second embodiment further includes a designated receiving place obtaining unit 55.

The destination and receiving place output unit 54 outputs the passenger's destination or the designated receiving place to the automatic driving controller 4. The destination and receiving place output unit 54 reads destination information stored in the destination and contact storage 65 and outputs the destination information to the automatic driving controller 4. The destination and receiving place output unit 54 also reads designated receiving place information stored in the designated receiving place storage 69 and outputs the information to the automatic driving controller 4.

The designated receiving place obtaining unit 55 receives, through the input-output interface 20, receiving place information received by the communication device 17 from the taxi dispatch center, and stores the information into the designated receiving place storage 69 as designated receiving place information. The designated receiving place obtaining unit 55 may also obtain receiving place information by reading a conversation with an operator of the security agency or an emergency call center stored in the conversation storage 63, and store the information into the designated receiving place storage 69 as designated receiving place information.

In the second embodiment, the guidance information storage 64 stores guidance information that asks an operator of the security agency or an emergency call center for a receiving place. The notification output unit 51 then reads the guidance information from the guidance information storage 64 and outputs the information to the communication device 17 to provide voice guidance that asks the operator of the security agency or an emergency call center answering the telephone for a receiving place through the communication device 17.

In addition to reading the passenger monitoring video data from the monitoring video storage 61 to determine whether the passenger is able to exit the vehicle, the passenger state determination unit 49 determines whether the passenger is in a state appropriate to receive an awakening operation, in other words, the passenger may receive a stimulus, or not (in a state inappropriate to receive an awakening operation) depending on whether the passenger is, for example, suffering or bleeding.

### Operation

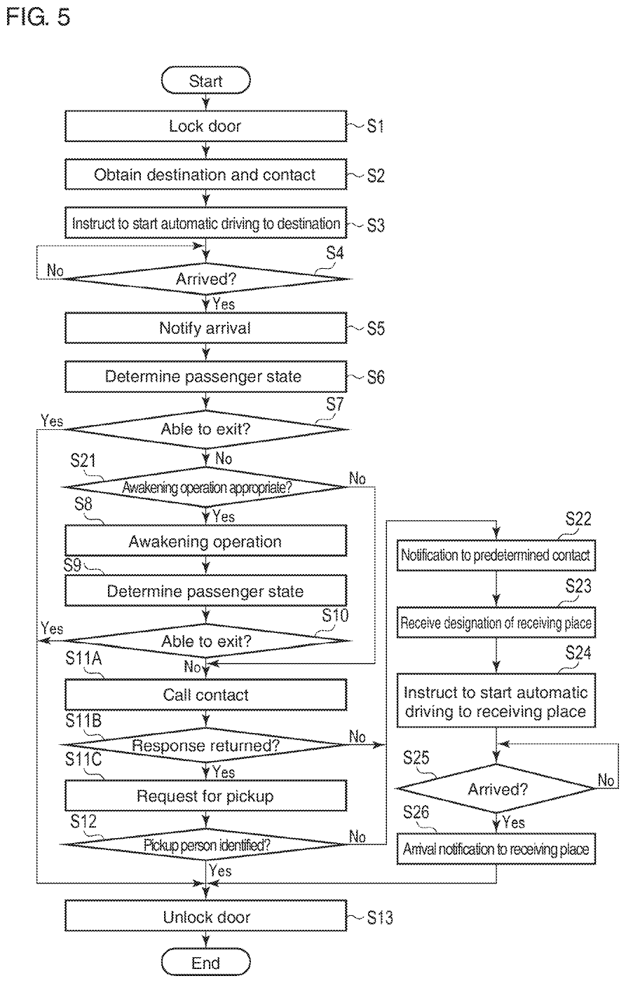

The operation of the passenger assisting apparatus 11 with the above structure will now be described. FIG. 5 is a flowchart showing the overall passenger assisting procedure and operation.

The processing in steps S1 to S7 in 1. Passenger Entering the Vehicle, 2. Obtaining Destination and Contact, 3. Automatic Driving, and 4. Determining Passenger State is the same as in the first embodiment.

### 5. Awakening Operation

When the passenger is determined unable to exit the vehicle in step S7, the passenger assisting apparatus 11 determines whether the passenger is in a state appropriate to receive an awakening operation in step S21 before performing the awakening operation. For example, the awakening assistance unit 50 in the control unit 40 reads the passenger state determination result stored in the passenger state storage 66. When all the passengers are unable to exit the vehicle, the awakening assistance unit 50 determines whether each passenger is in a state appropriate to receive an awakening operation.

With each passenger is in a state appropriate to receive an awakening operation, the awakening assistance unit 50 may output awakening assistance information to the stimulus output device 16, which can provide a stimulus to all the passengers to promote awakening in step S8. When at least one of the passengers is in a state inappropriate to receive an awakening operation, the awakening assistance unit 50 provides a stimulus from the stimulus output device 16 to each passenger to promote awakening, excluding the passenger(s) inappropriate to receive an awakening operation.

In contrast, when no passenger is in a state appropriate to receive an awakening operation, no awakening operation is performed. The processing advances to step 511, in which a notification is provided to the passenger's contact.

### 6. Providing Notification to Contact

The processing in step 510 in 6. Providing Notification to Contact is the same as in the first embodiment.

In the second embodiment, the processing in step S11 includes steps S11A, S11B, and S11C.

In step S11A, the notification output unit 51 in the control unit 40 first reads, for example, the passenger state determination result stored in the passenger state storage 66. When all the passengers remain unable to exit the vehicle, the notification output unit 51 reads the telephone number indicated by each passenger's contact stored in the destination and contact storage 65, and causes the communication device 17 to call the contact. In step S11B, the notification output unit 51 then reads a conversation stored in the conversation storage 63 with a responder from the contact, and determines whether a response has been returned from the contact. When detecting a response from the contact, the notification output unit 51 in step S11C reads guidance information stored in the guidance information storage 64, such as voice guidance that requests a person to pick up the passengers, and provides the information to the responder answering the telephone through the communication device 17.

The processing in step S12 in 7. Identifying Person to Pick up Passenger and step S13 in 8. Passenger Exiting the Vehicle is the same as in the first embodiment.

### 9. Traveling to Receiving Place

When detecting no response from the contact in step S11B or no person to pick up the passengers within a predetermined time period in step S12, the passenger assisting apparatus 11 causes the vehicle to travel to a receiving place. The determination as to whether a person has come from the contact to pick up the passengers in step S12 may also be based on whether the pickup request is rejected in step S110. This enables the processing to immediately shift to the traveling to a receiving place without waiting for a person to come to pick up the passengers for the predetermined time period.

To travel to the receiving place, for example, the notification output unit 51 in the control unit 40 in step S22 reads predetermined contact stored in the predetermined contact storage 68, for example, the network address of the taxi dispatch center, and causes the communication device 17 notifies the taxi dispatch center of the current position of the vehicle and the current situation. The designated receiving place obtaining unit 55 in the control unit 40 then, in step S23, obtains information about a receiving place such as the nearest police station or hospital from the taxi dispatch center through the communication device 17, and stores the information into the designated receiving place storage 69.

In some embodiments, the notification output unit 51 in step S22 may provide a notification to the security agency or an emergency call center. In this case, the notification output unit 51 reads the telephone number of the security agency or the emergency telephone number, which is the predetermined contact stored in the predetermined contact storage 68, and causes the communication device 17 to call the telephone number. The notification output unit 51 then reads guidance information appropriate to the passenger state from the guidance information storage 64, and notifies the operator of the security agency or the emergency call center of the current position of the vehicle and also the guidance information. In step S23, the designated receiving place obtaining unit 55 then obtains the police station or the hospital designated as a receiving place based on the information obtained through the communication device 17 and stored in the conversation storage 63 about the conversation with the operator of the security agency or the emergency call center, and stores the receiving place information into the designated receiving place storage 69.

The existing navigation system may allow use of one of the name, the address, and the telephone number of the designated receiving place to obtain the remaining two sets of information.

After the receiving place is obtained in this manner, the passenger assisting apparatus 11 instructs the automatic driving controller 4 to start automatic driving to the designated receiving place in step S24. For example, the destination and receiving place output unit 54 in the control unit 40 reads the address of the designated receiving place from the designated receiving place storage 69, and outputs the address to the automatic driving controller 4. In accordance with the output receiving place information, the automatic driving controller 4 performs the automatic driving to the address of the receiving place.

In step S25, the passenger assisting apparatus 11 waits for the arrival at the designated receiving place. For example, the control unit 40 determines whether the vehicle has arrived at the designated receiving place as controlled by the automatic driving determination unit 47, and repeats the processing in this step until the arrival at the receiving place.

When detecting the arrival at the designated receiving place, the passenger assisting apparatus 11 provides a notification about the arrival at the designated receiving place to the same receiving place in step S26. For example, the notification output unit 51 in the control unit 40 reads the telephone number of the designated receiving place stored in the designated receiving place storage 69, and causes the communication device 17 to call the telephone number. The notification output unit 51 reads and provides arrival notification guidance information from the guidance information storage 64 to the receiving place.

The processing then advances to step S13, in which the passenger assisting apparatus 11 causes the door lock controller 53 in the control unit 40 to control the door lock device 15 to unlock the door. Like the traveling to the destination, the traveling to the designated receiving place may also be followed by identifying the person to pick up the passenger before the door is unlocked.

For the subsequent procedure for receiving the fare, the function is provided in the taxi system using fully automated driving, and will not be described in detail. For payment by card, an alarm is output to prevent the card from being left. For payment in cash, a bill and a printout about a method of payment are output.

### Effects

As described in detail in the second embodiment of the present invention, a stimulus is provided after the determination as to whether the passenger is in a state appropriate to receive the stimulus, in addition to the same effects as produced by the first embodiment of the present invention. This embodiment ensures the safety of the passenger by providing no stimulus to the passenger in a state inappropriate to receive a stimulus.

When no person comes from the contact to pick up the passenger, no person answers the call to the contact, or the request to pick up the passenger is rejected, the vehicle can travel to a predetermined receiving place such as a police station or a hospital to send the passenger to be received by a police officer or a doctor. This ensures the safety of the passenger until the passenger exits the vehicle, and allows the service to continue.

Additionally, the vehicle can communicate with the taxi dispatch center or call the telephone number of the security agency or an emergency telephone number to receive the designation of a receiving place, and travel to the designated receiving place. This allows the vehicle to send the passenger to an appropriate receiving place determined based on the distance from the current position of the vehicle and the capability of the receiving place.

### Third Embodiment

### Structure

A passenger assisting apparatus 11 according to a third embodiment of the present invention has the same structure as the passenger assisting apparatus 11 in FIG. 2 according to the first embodiment, and is not shown.

In the third embodiment, the arrival determination unit 48 determines whether the vehicle 1 has reached the vicinity of the passenger's destination, in addition to determining whether the vehicle 1 has arrived at the destination. The vicinity of the destination includes a predetermined distance range, such as a range of 100 meters from the destination. In some embodiments, the vicinity includes a predetermined time range, such as a range of one minute in which the vehicle will arrive at the destination. The time range is calculated based on the distance to the destination and the traffic conditions. The destination vicinity is not limited to a value such as 100 meters or one minute from the destination. The vicinity may include a distance or a time period in which the passenger state remains unchanged. The distance or the time period are determined by deep learning using data from a large number of samples or academically or statistically derived. The value indicating the destination vicinity may be stored in a memory (not shown) included in the arrival determination unit 48 or, for example, prestored in the destination and contact storage 65.

### Operation

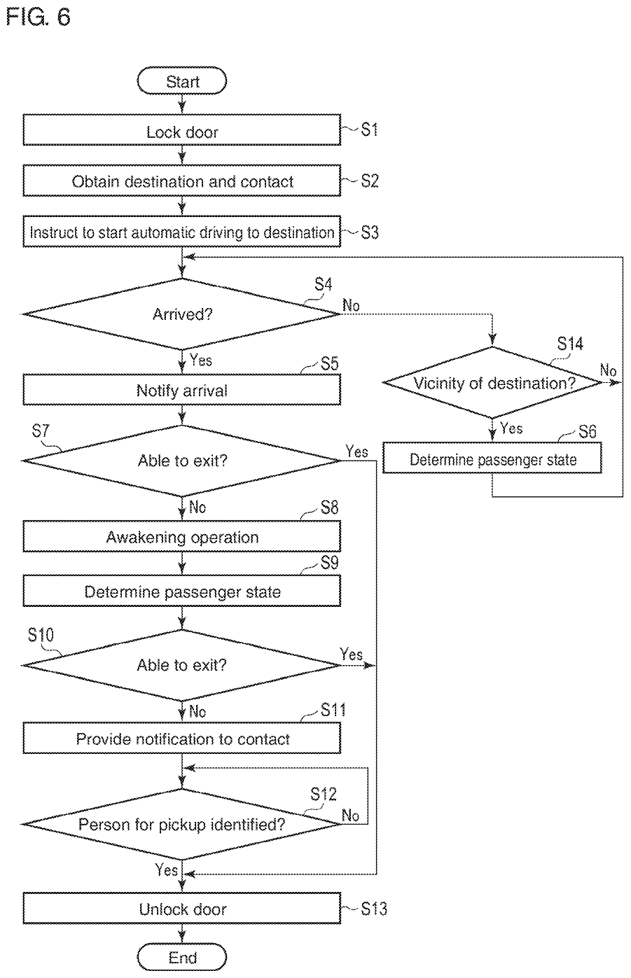

The operation of the passenger assisting apparatus 11 with the above structure will now be described. FIG. 6 is a flowchart showing the overall passenger assisting procedure and operation. The processing different from the first embodiment will be described mainly.

In the third embodiment, when the arrival determination unit 48 determines that the vehicle 1 has yet to arrive at the destination in step S4, as in the first embodiment, the arrival determination unit 48 further determines whether the vehicle 1 has reached the vicinity of the destination in step S14. When the vehicle 1 is determined yet to reach the destination vicinity, the passenger assisting apparatus 11 returns the processing to step S4.

When the arrival determination unit 48 determines that the vehicle 1 has reached the vicinity of the destination, the passenger assisting apparatus 11 advances the processing to step S6. In this step, the passenger state determination unit 49 in the control unit 40 reads the passenger monitoring video data from the monitoring video storage 61, determines the states of all passengers based on the passenger monitoring video data, and stores the determination result information into the passenger state storage 66. The passenger assisting apparatus 11 then returns the processing to step S4.

When detecting the arrival at the destination, the passenger assisting apparatus 11 notifies the passenger of the arrival at the destination in step S5. In the third embodiment, the processing then advances to step S7 to determine whether the determination result from the passenger state determination unit 49 indicates a state in which the passenger is able to exit the vehicle. The processing in steps S7 to S13 is the same as in the first embodiment.

More specifically, in the third embodiment, the passenger state is obtained when the vehicle reaches the destination vicinity before arriving at the destination. When detecting the arrival at the destination, the vehicle performs an operation appropriate to the obtained passenger state. This is because the destination vicinity is set at a value with a high probability that the passenger state obtained in the destination vicinity remains unchanged until the vehicle 1 arrives at the destination.

### Effects

As described in detail in the third embodiment of the present invention, the passenger state is obtained in advance or before the arrival at the destination. When detecting the arrival at the destination, the vehicle can immediately shift to an operation appropriate to the passenger state. This shortens the time taken from the arrival at the destination to the shift to the operation.

The passenger state may be obtained in advance also in the second embodiment, as in the third embodiment.

### Fourth Embodiment

### Structure

A passenger assisting apparatus 11 according to a fourth embodiment of the present invention has the same structure as the passenger assisting apparatus 11 in FIG. 2 according to the first embodiment, and is not shown.

In the fourth embodiment, as in the third embodiment, the arrival determination unit 48 determines whether the vehicle 1 has arrived at the passenger's destination and whether the vehicle 1 has reached the vicinity of the destination.

### Operation

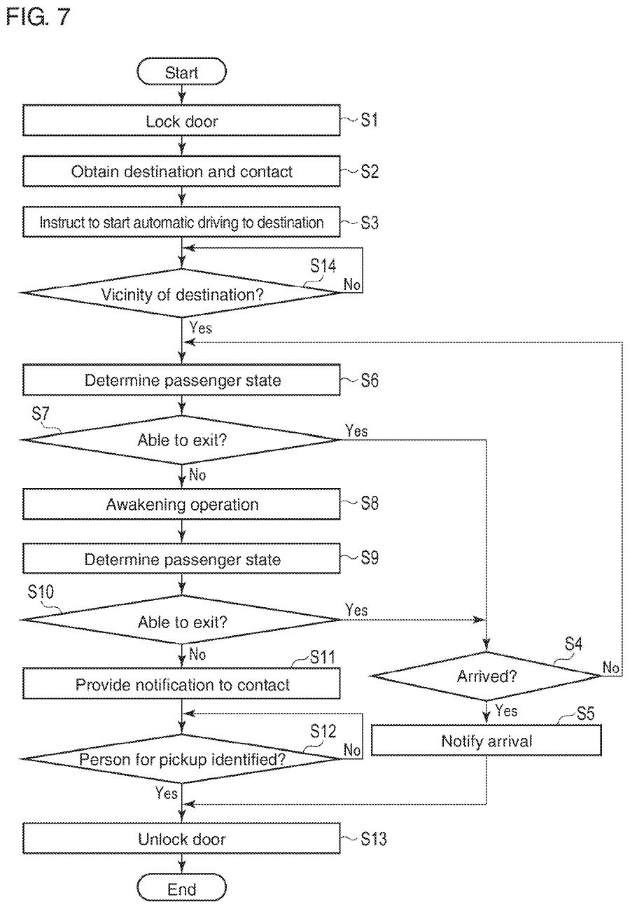

The operation of the passenger assisting apparatus 11 with the above structure will now be described. FIG. 7 is a flowchart showing the overall passenger assisting procedure and operation. The processing different from the first embodiment will be described mainly.

In step S3 as in the first embodiment, the automatic driving controller 4 is instructed to start automatic driving to the passenger's destination. The passenger assisting apparatus 11 in the fourth embodiment then waits for the arrival in the vicinity of the destination in step S14. For example, the control unit 40 causes the arrival determination unit 48 to determine whether the vehicle 1 has reached the vicinity of the destination, and repeats the step until detecting the vehicle 1 reaching the destination vicinity.

When the arrival determination unit 48 determines that the vehicle 1 has reached the vicinity of the destination, the passenger assisting apparatus 11 in step S6 causes the passenger state determination unit 49 to determine the states of all passengers and store the determination result information into the passenger state storage 66.

The passenger assisting apparatus 11 then determines whether the determination result information stored in the passenger state storage 66 indicates a state in which the passenger is able to exit the vehicle in step S7. When the determination result from the passenger state determination unit 49 indicates a state in which the passenger is able to exit the vehicle, the passenger assisting apparatus 11 in step S4, for example, causes the arrival determination unit 48 to determine whether the vehicle 1 has arrived at the destination. When the vehicle 1 is determined yet to arrive at the destination, the passenger assisting apparatus 11 returns the processing to step S6. When the vehicle 1 is determined to have arrived at the destination in step S4, the passenger assisting apparatus 11 in step S5 notifies the passenger of the arrival at the destination, and then advances the processing to step S13 to unlock the door.

In step S7, when determining that the passenger is unable to exit the vehicle, the passenger assisting apparatus 11 performs the processing in steps S8 to S13 as in the first embodiment. However, in step S10, when determining that the determination result from the passenger state determination unit 49 indicates a state in which the passenger is able to exit the vehicle, the passenger assisting apparatus 11 advances the processing to step S4.

More specifically, in the fourth embodiment, the passenger state is obtained when the vehicle reaches the destination vicinity before arriving at the destination. When the obtained state indicates that the passenger is unable to exit the vehicle, an awakening operation is performed before the arrival at the destination.

### Effects

As described in detail above, in the fourth embodiment of the present invention, the passenger state is obtained in advance or before the arrival at the destination. When the passenger is unable to exit the vehicle, the vehicle can shift to an awakening operation before the arrival at the destination, increasing the probability that the passenger is awake at the arrival at the destination.

The passenger state may be obtained in advance also in the second embodiment, as in the fourth embodiment.

### Other Embodiments

In the first to fourth embodiments, the determination as to whether the passenger is in a state to exit the vehicle is performed when the vehicle arrives at the destination or reaches the destination vicinity. However, the determination may be constantly performed while the passenger is on the vehicle 1.

In the first to fourth embodiments, the passenger state detection sensor is each interior view camera 12 to determine the passenger state based on a video signal including the passenger's face obtained by the interior view camera 12. However, the passenger state detection sensor may be other than the interior view camera 12 and may be, for example, a vital sign sensor that obtains the passenger's vital signs. The passenger state may be determined based on vital signals for the obtained by the vital sign sensor, such as pulse wave signals detected by a pulse wave sensor, heartbeat signals detected by a heartbeat sensor, or signals indicating the passenger's diaphragm moving up and down detected by a pressure sensor.

Although the vehicle 1 is a taxi with fully automated driving in the above embodiments, the vehicle 1 may also be a fully automated private automobile. In this case, when the destination is the home, the contact, which can be preregistered, is not obtained in step S2 in the first and second embodiments.

Other details including the type of vehicle, the functions of the automatic driving controller, and the procedure and the operation for assisting the passenger performed by the passenger assisting apparatus may be modified variously without departing from the spirit and scope of the present invention.

The present invention is not limited to the embodiments described above, but may be variously modified without departing from the spirit and scope of the invention. The above embodiments may be combined in any possible manner to achieve effects produced by such combinations. The above embodiments include various stages of the invention, and the components described herein may further be selected or combined to provide various aspects of the invention.

The above embodiments may be partially or entirely expressed in, but not limited to, the following forms shown in the appendixes below.

### APPENDIX 1

A passenger assisting apparatus mountable on an autonomous vehicle including an automatic driving controller and configured to assist a passenger on the autonomous vehicle, the apparatus comprising a hardware processor and a memory, the hardware processor being configured to

obtain a destination and a contact of the passenger, and store the destination and the contact into the memory,

determine whether the passenger is able to exit the vehicle based on a sensing result from a passenger state detection sensor for detecting a state of the passenger, and store a result of the determination into the memory,

perform an awakening operation for the passenger when the determination result stored in the memory indicates that the passenger is unable to exit the vehicle,

redetermine whether the passenger is able to exit the vehicle based on a sensing result from the passenger state detection sensor for detecting the state of the passenger after the awakening operation is performed, and store a result of the redetermination into the memory, and

provide a notification to the contact stored in the memory when the redetermination result stored in the memory indicates that the passenger remains unable to exit the vehicle.

### APPENDIX 2

A passenger assisting method implemented by an apparatus mountable on an autonomous vehicle including an automatic driving controller and configured to assist a passenger on the autonomous vehicle, the method comprising:

obtaining, with a hardware processor, a destination and a contact of the passenger, and store the destination and the contact into the memory;

determining, with the hardware processor, whether the passenger is able to exit the vehicle based on a sensing result from a passenger state detection sensor for detecting a state of the passenger, and store a result of the determination into the memory;

performing, with the hardware processor, an awakening operation for the passenger when the determination result stored in the memory indicates that the passenger is unable to exit the vehicle;

redetermining, with the hardware processor, whether the passenger is able to exit the vehicle based on a sensing result from the passenger state detection sensor for detecting the state of the passenger after the awakening operation is performed, and store a result of the redetermination into the memory; and

providing, with the hardware processor, a notification to the contact stored in the memory when the redetermination result stored in the memory indicates that the passenger remains unable to exit the vehicle.

1. A passenger assisting apparatus mountable on an autonomous vehicle comprising an automatic driving controller and configured to assist a passenger on the autonomous vehicle, the apparatus comprising: a processor configured with a program to perform operations comprising:
operation as a passenger information obtaining unit configured to obtain a destination and a contact of the passenger;
operation as a state determination unit configured to determine whether the passenger is able to exit the vehicle based on a sensing result from a passenger state detection sensor for detecting a state of the passenger;
operation as an awakening assistance unit configured to perform an awakening operation for the passenger in response to the state determination unit determining that the passenger is unable to exit the vehicle; and
operation as a contact notification unit configured to provide a notification to the contact obtained by the passenger information obtaining unit in response to the state determination unit determining that the passenger is unable to exit the vehicle after the awakening operation performed by the awakening assistance unit.

2. The passenger assisting apparatus according to claim 1, wherein
the processor is configured with the program perform operations further comprising:
operation as an arrival determination unit configured to determine whether the autonomous vehicle has arrived at the destination of the passenger or reached a vicinity of the destination, and
the processor is configured with the program perform operations such that operation as the state determination unit further comprises determining whether the passenger is able to exit the vehicle in response to the arrival determination unit determining that the autonomous vehicle has arrived at the destination of the passenger or reached the vicinity.

3. The passenger assisting apparatus according to claim 1, wherein the processor is configured with the program perform operations further comprising:
operation as a situation determination unit configured to determine whether a person has come from the contact to pick up the passenger; and
operation as a door lock controller configured to lock a door at a doorway for the passenger at start of driving with at least the passenger on the autonomous vehicle, and unlock the door in response to the state determination unit determining that the passenger is able to exit the vehicle or the situation determination unit determines that a person has come from the contact to pick up the passenger.

4. The passenger assisting apparatus according to claim 3, wherein the processor is configured with the program perform operations such that:
operation as the contact notification unit further comprises providing, to the contact, the notification comprising identification information identifying a person to pick up the passenger, and
operation as the situation determination unit further comprises determining that a person has come from the contact to pick up the passenger based on the identification information presented by the person.

5. The passenger assisting apparatus according to claim 3, wherein
the processor is configured with the program perform operations further comprising:
operation as a traveling-to-receiving place control unit configured to cause the automatic driving controller to move the autonomous vehicle to a predetermined receiving place and provide a notification to the receiving place in response to the situation determination unit determining that no person comes from the contact to pick up the passenger or in response to the contact notification unit failing to provide a notification to the contact, and
the processor is configured with the program perform operations such that operation as the door lock controller further comprises unlocking the door in response to arrival at the receiving place.

6. The passenger assisting apparatus according to claim 5, wherein the processor is configured with the program perform operations further comprising:
operation as a receiving place designation unit configured to receive designation of the predetermined receiving place.

7. The passenger assisting apparatus according to claim 1, wherein the processor is configured with the program perform operations such that:
operation as the state determination unit further comprises determining whether the passenger is in a state appropriate to receive the awakening operation performed by the awakening assistance unit based on the sensing result from the passenger state detection sensor for detecting the state of the passenger, and
operation as the awakening assistance unit further comprises performing performs the awakening operation in response to the state determination unit determining that the passenger is in a state appropriate to receive the awakening operation.

8. A passenger assisting method implemented by an apparatus mountable on an autonomous vehicle comprising an automatic driving controller and configured to assist a passenger on the autonomous vehicle, the method comprising:
obtaining a destination and a contact of the passenger;
determining whether the passenger is able to exit the vehicle based on a sensing result from a passenger state detection sensor for detecting a state of the passenger;
performing an awakening operation for the passenger in response to the passenger being determined unable to exit the vehicle in the determining whether the passenger is able to exit the vehicle;
redetermining whether the passenger is able to exit the vehicle based on a sensing result from the passenger state detection sensor after the awakening operation is performed in the performing the awakening operation; and
providing a notification to the contact obtained in the obtaining the destination and the contact of the passenger in response to the passenger being determined unable to exit the vehicle in the redetermining whether the passenger is able to exit the vehicle.

9. A non-transitory computer-readable storage medium storing a passenger assisting program, which when read and executed, causes a computer to perform the operations comprised in the passenger assisting apparatus according to claim 1.

10. The passenger assisting apparatus according to claim 2, wherein the processor is configured with the program perform operations further comprising:
operation as a situation determination unit configured to determine whether a person has come from the contact to pick up the passenger; and
operation as a door lock controller configured to lock a door at a doorway for the passenger at start of driving with at least the passenger on the autonomous vehicle, and unlock the door in response to the state determination unit determining that the passenger is able to exit the vehicle or the situation determination unit determines that a person has come from the contact to pick up the passenger.

11. The passenger assisting apparatus according to claim 10, wherein the processor is configured with the program perform operations such that:
operation as the contact notification unit further comprises providing, to the contact, the notification comprising identification information identifying a person to pick up the passenger, and
operation as the situation determination unit further comprises determining that a person has come from the contact to pick up the passenger based on the identification information presented by the person.

12. The passenger assisting apparatus according to claim 10, wherein
the processor is configured with the program perform operations further comprising:
operation as a traveling-to-receiving place control unit configured to cause the automatic driving controller to move the autonomous vehicle to a predetermined receiving place and provide a notification to the receiving place in response to the situation determination unit determining that no person comes from the contact to pick up the passenger or in response to the contact notification unit failing to provide a notification to the contact, and
the processor is configured with the program perform operations such that operation as the door lock controller further comprises unlocking the door in response to arrival at the receiving place.

13. The passenger assisting apparatus according to claim 12, wherein the processor is configured with the program perform operations further comprising:
operation as a receiving place designation unit configured to receive designation of the predetermined receiving place.

14. The passenger assisting apparatus according to claim 4, wherein
the processor is configured with the program perform operations further comprising:
operation as a traveling-to-receiving place control unit configured to cause the automatic driving controller to move the autonomous vehicle to a predetermined receiving place and provide a notification to the receiving place in response to the situation determination unit determining that no person comes from the contact to pick up the passenger or in response to the contact notification unit failing to provide a notification to the contact, and
the processor is configured with the program perform operations such that operation as the door lock controller further comprises unlocking the door in response to arrival at the receiving place.

15. The passenger assisting apparatus according to claim 14, wherein the processor is configured with the program perform operations further comprising:
operation as a receiving place designation unit configured to receive designation of the predetermined receiving place.

16. The passenger assisting apparatus according to claim 2, wherein the processor is configured with the program perform operations such that:
operation as the state determination unit further comprises determining whether the passenger is in a state appropriate to receive the awakening operation performed by the awakening assistance unit based on the sensing result from the passenger state detection sensor for detecting the state of the passenger, and
operation as the awakening assistance unit further comprises performing the awakening operation in response to the state determination unit determining that the passenger is in a state appropriate to receive the awakening operation.

17. The passenger assisting apparatus according to claim 3, wherein the processor is configured with the program perform operations such that:
operation as the state determination unit further comprises determining whether the passenger is in a state appropriate to receive the awakening operation performed by the awakening assistance unit based on the sensing result from the passenger state detection sensor for detecting the state of the passenger, and
operation as the awakening assistance unit further comprises performing the awakening operation in response to the state determination unit determining that the passenger is in a state appropriate to receive the awakening operation.

18. The passenger assisting apparatus according to claim 4, wherein the processor is configured with the program perform operations such that:
operation as the state determination unit further comprises determining whether the passenger is in a state appropriate to receive the awakening operation performed by the awakening assistance unit based on the sensing result from the passenger state detection sensor for detecting the state of the passenger, and
operation as the awakening assistance unit further comprises performing the awakening operation in response to the state determination unit determining that the passenger is in a state appropriate to receive the awakening operation.

19. The passenger assisting apparatus according to claim 5, wherein the processor is configured with the program perform operations such that:
operation as the state determination unit further comprises determining whether the passenger is in a state appropriate to receive the awakening operation performed by the awakening assistance unit based on the sensing result from the passenger state detection sensor for detecting the state of the passenger, and
operation as the awakening assistance unit further comprises performing the awakening operation in response to the state determination unit determining that the passenger is in a state appropriate to receive the awakening operation.

20. The passenger assisting apparatus according to claim 6, wherein the processor is configured with the program perform operations such that:
operation as the state determination unit further comprises determining whether the passenger is in a state appropriate to receive the awakening operation performed by the awakening assistance unit based on the sensing result from the passenger state detection sensor for detecting the state of the passenger, and
operation as the awakening assistance unit further comprises performing the awakening operation in response to the state determination unit determining that the passenger is in a state appropriate to receive the awakening operation.
